(19) United States
(12) Patent Application Publication
(10) Pub. No.: US 2024/0080882 A1
(43) Pub. Date: Mar. 7, 2024

(54) Managing Small Data Transmission in Inactive State Scenarios

(71) Applicant: Google LLC 1600, Mountain View, CA (US)

(72) Inventor: Shiangrung Ye, Sanchong District,New Taipei City Taiwan (TW)

(21) Appl. No.: 18/261,260

(22) PCT Filed: Jan. 7, 2022
(86) PCT No.: PCT/US22/11534

§ 371 Date: Jul. 12, 2023

Related U.S. Application Data
(60) Provisional application No. 63/199,634, filed on Jan. 13, 2021.
(60) Provisional application No. 63/136,554, filed on Jan. 12, 2021.

(51) Int. Cl. H04W 74/00; H04W 74/08

(52) U.S. Cl. CPC H04W 74/006; H04W 74/0833

(57) ABSTRACT

A method in a user equipment (UE) for communicating with a base station includes receiving (602), from the base station, a configured grant for the UE to utilize when operating in an inactive state associated with a protocol for controlling radio resources. The method also includes transmitting (604), when the UE is in the inactive state, a message to the base station using the configured grant and detecting (606), within a predetermined interval after transmitting the message, uplink data addressed to the base station. The method further includes, in response to the detecting, performing (608) a random access procedure with the base station, including transmitting a payload with (i) an indication of the uplink data and (ii) an identifier of the UE obtained by the UE prior to performing the random access procedure.

### FIELD OF THE DISCLOSURE

This disclosure relates to wireless communications and, more particularly, to techniques for managing small data transmission (SDT).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating as the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MCG but using the lower-layer resources of the MN, the SN, or both the MN and the SN can be referred to as split DRBs.

The UE in some scenarios can concurrently utilize resources of multiple nodes (e.g., base stations or components of a distributed base station) of a radio access network (RAN), interconnected by a backhaul. In these scenarios, the UE is considered to be operating in multi-connectivity (MC) with the multiple nodes. For example, when the UE concurrently utilizes resources of two network nodes, the UE is considered to be operating in dual connectivity with the two network nodes. When these network nodes support different radio access technologies (RATs), such as 5G NR and EUTRA, this type of connectivity is referred to as Multi-Radio Dual Connectivity (MR-DC). When a UE operates in MR-DC, one base station operates as the MN that covers a primary cell (PCell), and the other base station operates as the SN that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station), interconnected to other network elements by a backhaul.

The MN can provide a control-plane connection and a user-plane connection to a core network (CN), whereas the SN generally provides a user-plane connection. A base station (e.g., MN, SN) and/or the CN in some cases causes the UE to transition from one state of the RRC protocol to another state. More particularly, the UE can operate in an idle state (e.g., EUTRA-RRC_IDLE, NR-RRC IDLE), in which the UE does not have a radio connection with a base station; a connected state (e.g., EUTRA-RRC_CONNECTED, NR-RRC CONNECTED), in which the UE has a radio connection with the base station; or an inactive state (e.g., EUTRA-RRC INACTIVE, NR-RRC INACTIVE), in which the UE has a suspended radio connection with the base station.

While operating in the inactive state, the UE can transmit data to the base station using time and/or frequency resources specified by a configured grant. After transmitting data in accordance with a configured grant, the UE may detect pending data that is addressed to the base station. Generally speaking, UEs transmit a buffer status report to the base station by performing a random access procedure. However, in the inactive state, the UE does not have a cell radio network temporary identifier (C-RNTI) with which to identify the UE to the base station during the random access procedure.

### SUMMARY

The techniques of this disclosure enable a UE operating in an inactive state to identify the UE to a base station during the random access procedure. Initially, the UE transmits a message (e.g., an RRCResumeRequest message) to the base station in accordance with a configured grant (e.g., in order to perform small data transmission (SDT)). The UE then detects uplink data addressed to the base station within a predetermined interval after transmitting the message. For example, the UE can start a timer in response to transmitting the message, and detect the uplink data while the timer is running.

In response to detecting the uplink data, the UE performs a random access procedure with the base station. During the random access procedure, the UE transmits a payload (e.g., in a MsgA of a two-step random access procedure or a Msg3 of a four-step random access procedure) with (i) an indication of the uplink data and (ii) an identifier of the UE obtained by the UE prior to performing the random access procedure. The indication of the uplink data may be a buffer status report (BSR). By using a previously-obtained identifier, the UE does not need to wait for a random access response including a temporary C-RNTI (TC-RNTI) to generate or to transmit the payload of the random access procedure. The identifier can vary by implementation.

In some implementations, the base station transmits the identifier to the UE in response to receiving the message in accordance with the configured grant. The identifier, for example, can be a C-RNTI. The UE can then transmit the C-RNTI in the payload within a C-RNTI medium access control (MAC) control element (CE).

In other implementations, the base station configures the UE with an RNTI dedicated for use in the inactive state. For example, the base station can transmit the RNTI to the UE in an RRCRelease message that causes the UE to transition to the inactive state. The UE can then include this RNTI in the payload, such as within a C-RNTI MAC CE.

In yet other implementations, the identifier corresponds to the message that the UE transmitted using the configured grant. For example, if the message is an RRCResumeRequest message, the UE can include the RRCResumeRequest, or a common control channel (CCCH) service data unit (SDU) of the RRCResumeRequest, in a UE Contention Resolution Identity MAC CE included in the payload.

One example embodiment of these techniques is a method implemented in a UE for communicating with a base station. The method can be executed by processing hardware and includes receiving, from the base station, a configured grant for the UE to utilize when operating in an inactive state associated with a protocol for controlling radio resources. The method also includes transmitting, when the UE is in the inactive state, a message to the base station using the configured grant and detecting, within a predetermined interval after transmitting the message, uplink data addressed to the base station. The method further includes, in response to the detecting, performing random access procedure with the base station, including transmitting a payload with (i) an indication of the uplink data and (ii) an identifier of the UE obtained by the UE prior to performing the random access procedure.

Another example embodiment of these techniques is a UE including processing hardware and configured to implement the method above.

Another example embodiment of these techniques is a method implemented in a base station for communicating with a UE. The method can be executed by processing hardware and includes transmitting, to the UE, a configured grant for the UE to utilize when operating in an inactive state associated with a protocol for controlling radio resources. The method further includes receiving a transmission in accordance with the configured grant and, in response to receiving the transmission, transmitting, to the UE, an identifier for the UE to utilize to communicate with the base station.

Yet another example embodiment of these techniques is a base station including processing hardware and configured to implement the methods above.

### BRIEF DESCRIPTION OF THE DRAWINGS

FIG. 1 is a block diagram of an example system in which a base station of a radio access network (RAN) and a user equipment (UE) can implement the techniques of this disclosure for transmitting data when operating in an inactive state;

FIG. 2 is a block diagram of an example protocol stack according to which the UE of FIG. 1 communicates with base stations;

FIG. 3A is a messaging diagram of an example scenario in which a UE detects data addressed to the base station within a predetermined interval after transmitting a message in accordance with a configured grant, initiates a four-step random access procedure to transmit a buffer status report to the base station, and transmits a C-RNTI to the base station during the random access procedure;

FIG. 3B is a messaging diagram of an example scenario similar to the scenario of FIG. 3A, but where the UE initiates a two-step random access procedure;

FIG. 4 is a messaging diagram of an example scenario similar to the scenario of FIG. 3A, but where UE transmits an RNTI dedicated for use in the inactive state during the random access procedure instead of the C-RNTI;

FIG. 5 is a messaging diagram of an example scenario similar to the scenario of FIG. 3A, but where the UE transmits an indication of the message that the UE previously transmitted using the configured grant during the random access procedure instead of the C-RNTI;

FIG. 6 is a flow diagram of an example method for communicating with a base station, which can be implemented by a UE of this disclosure; and

FIG. 7 is a flow diagram of an example method for communicating with a UE, which can be implemented by a base station of this disclosure.

### DETAILED DESCRIPTION OF THE DRAWINGS

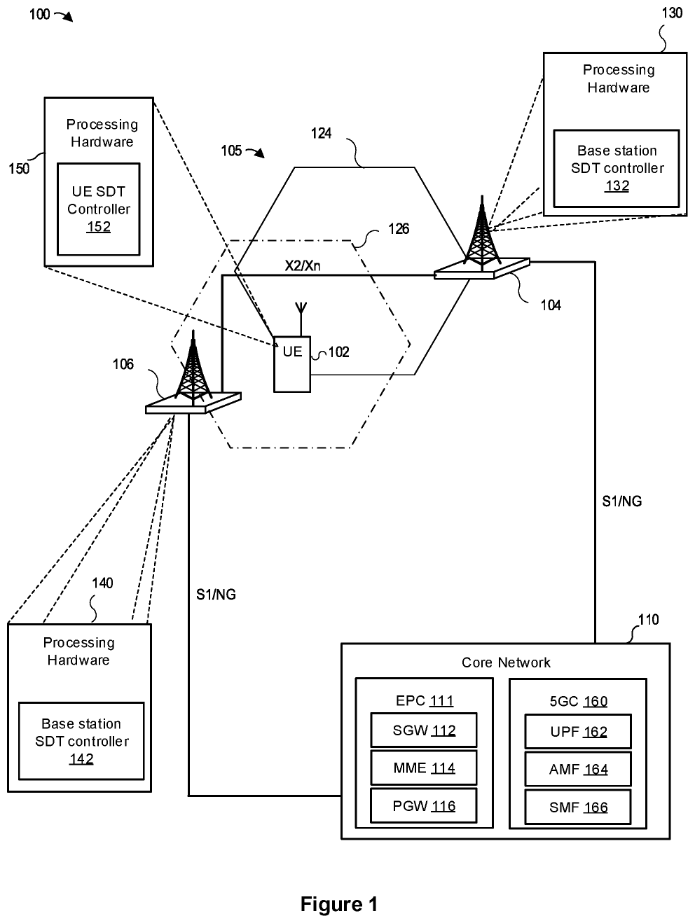

FIG. 1 depicts an example wireless communication system 100 that can implement the techniques of this disclosure. The wireless communication system 100 includes a UE 102, a base station 104, a base station 106, and a core network (CN) 110. The techniques of this disclosure can be implemented in the UE 102 or in one or both of the base stations 104 and 106.

The base stations 104 and 106 can be any suitable type, or types, of base stations, such as an evolved node B (eNB), a next-generation eNB (ng-eNB), or a 5G Node B (gNB), for example. The UE 102 can communication with the base station 104 and the base station 106 via the same radio access technology (RAT), such as EUTRA or NR, or different RATs. The base station 104 supports a cell 124, the base station 106 supports a cell 126. The cell 124 partially overlaps with the cell 126, such that the UE 102 can be in range to communicate with base station 104 while simultaneously being in range to communicate with the base station 106 (or in range to detect or measure the signal from the base station 106). The overlap can make it possible for the UE 102 to hand over between cells (e.g., from the cell 124 to the cell 126) or base stations (e.g., from the base station 104 to the base station 106). As another example, the UE 102 can communicate in dual connectivity (DC) with the base station 104 (operating as an MN) and the base station 106 (operating as an SN).

The base stations 104 and 106 operate in a radio access network (RAN) 105 connected to the CN 110, which can be an evolved packet core (EPC) 111 or a fifth-generation core (5GC) 160. The base station 104 can be implemented as an eNB supporting an S1 interface for communicating with the EPC 111, an ng-eNB supporting an NG interface for communicating with the 5GC 160, or as a gNB that supports the NR radio interface as well as an NG interface for communicating with the 5GC 160. The base station 106 can be implemented as an eNB with an S1 interface to the EPC 111, an ng-eNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104 and 106 can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

With continued reference to FIG. 1, the base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1 includes a base station SDT controller 132 that is configured to support the techniques of this disclosure, discussed below. Similarly, the base station 106 is equipped with processing hardware 140 and a base station SDT controller 142, which are similar to the processing hardware 130 and the SDT controller 132, respectively.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1 includes a UE SDT controller 152 that is configured to support the techniques of this disclosure, discussed below.

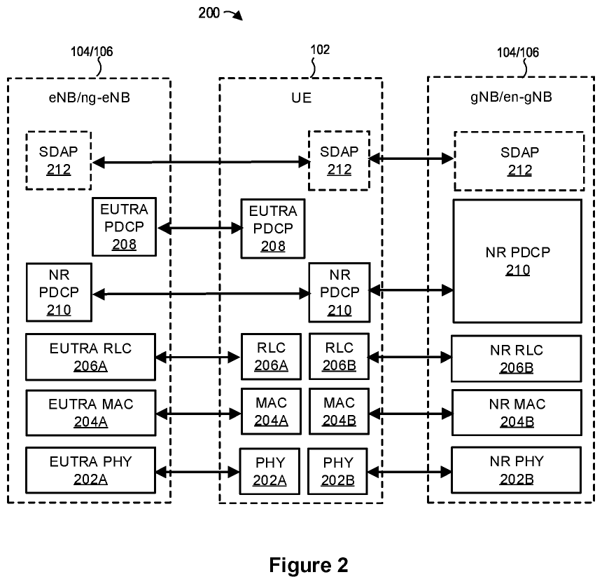

Next, FIG. 2 illustrates, in a simplified manner, an example protocol stack 200 according to which the UE 102 can communicate with an eNB/ng-eNB or a gNB (e.g., one or both of the base stations 104 and 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

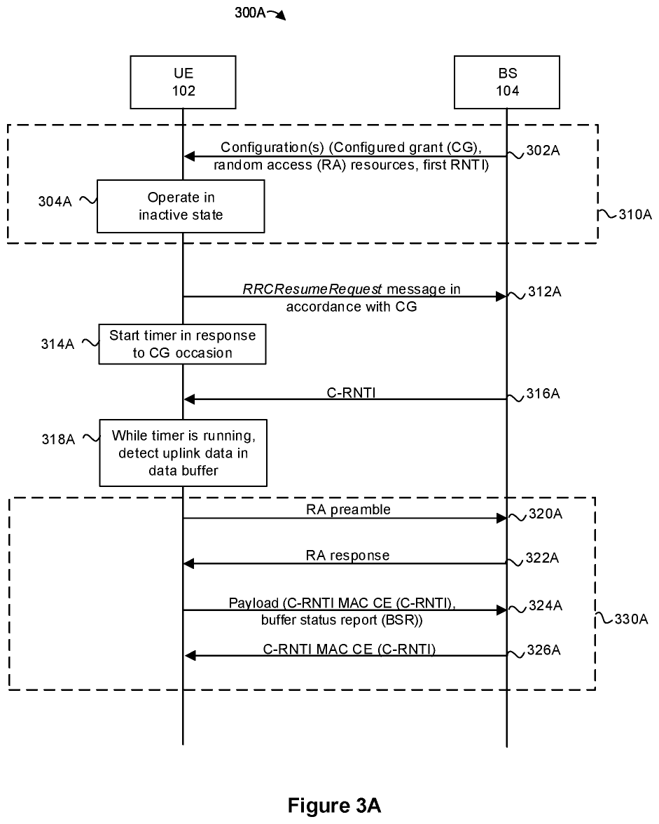

FIGS. 3A-5 are messaging diagrams of example scenarios in which a base station and UE implement the techniques of this disclosure for SDT. Generally speaking, events in FIGS. 3A-5 that are similar are labeled with similar reference numbers (e.g., event 312A is similar to events 312B, 412, 512, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Turning first to FIG. 3A, a UE 102 communicates with a base station 104 during a scenario 300A. Initially, the base station 104 transmits 302A a configuration message to the UE 102. The information included in the configuration message can vary depending on implementation. The configuration message at least includes one or more configured grants (CGs). A CG includes a radio resource configuration for a scheduled uplink transmission (e.g., time and/or frequency resources, periodicity, etc.). Each CG also may be associated with a beam, i.e., a spatial configuration.

The configuration message also includes random access (RA) resources for the UE 102 to utilize to initiate an random access procedure with the base station 104. The random access resources may include one or both of (a) a first type of random access resources for performing legacy random access procedures (i.e., non-SDT random access procedures) and (b) a second type of random access resources for performing RA-based SDT. The first type of random access resources include random access preambles and/or Physical Random Access Channel (PRACH) occasions for performing legacy random access procedures, which cause the UE 102 to transition to the connected state. A PRACH occasion is an occasion on which the UE 102 can transmit a random access preamble to initiate a random access procedure. The second type of random access resources include random access preambles and/or PRACH occasions that are dedicated for use in the inactive state. In particular, the RA preambles and/or PRACH occasions may be dedicated for performing RA-based SDT, which does not cause the UE 102 to transition to the connected state.

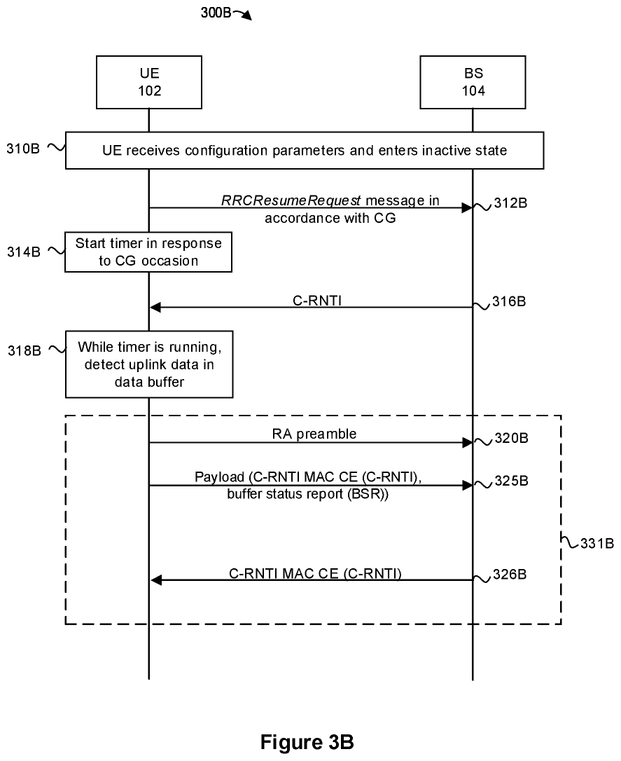

In some implementations, the configuration message includes a first RNTI. This first RNTI is an RNTI dedicated for use in the inactive state. In particular, the UE 102 can utilize the first RNTI when operating in the inactive state in order to detect and/or receive information transmitted from the base station 104. Similar to a C-RNTI, the first RNTI may be associated with the particular cell serving the UE 102 (e.g., the cell 124). In contrast to an inactive RNTI (I-RNTI), the first RNTI can be used by the base station 104 to scramble a cyclic redundancy check (CRC) attachment of a downlink control information (DCI). The UE 102 can use the first RNTI to descramble the CRC attachment and receive the DCI. The configuration message does not need to include the first RNTI in all implementations. For example, the first RNTI may be omitted in the scenario 300A because the techniques illustrated by FIG. 3A do not necessarily rely on the first RNTI. However, the techniques illustrated by FIG. 4 do utilize the first RNTI, as will be discussed below.

After or in response to the configuration message, the UE 102 begins 304A to operate in an inactive state. For example, the configuration message may be an RRC message that causes the UE 102 to transition to an inactive state, such as an RRCRelease message or an RRCReject message. While the event 304A refers to the UE 102 transitioning to an inactive state (e.g., RRC_INACTIVE), alternatively the UE 102 can transition to another state in which a UE does not have an active radio connection, such as an idle state (e.g., RRC_IDLE) with a suspended radio connection. The embodiments of this disclosure in general apply to an idle state with a suspended radio connection as well as to an inactive state. The events 302A and 304A are collectively referred to in this disclosure as an inactive state initiation procedure 310A.

While operating in the inactive state, the UE 102 transmits 312A a message in accordance with the CG included in the configuration message in order to perform CG-based SDT. The message may include uplink data and may be an RRC message. In particular, in the scenario 300A, the message is an RRCResumeRequest. Generally speaking, the message can be any suitable type of message for communicating with the base station 104 in accordance with a CG while operating in the inactive mode. For example, in other implementations, the message can be RRCSetupRequest, an RRCConnectionRequest, etc. Upon or in response to this CG occasion, the UE 102 starts 314A a timer. The length of the time window over which the timer runs may be preconfigured at the UE 102, and/or the base station 104 or another base station of the RAN 105 may transmit an indication of the time window length to the UE 102.

The time window of the timer may correspond to a time period during which the UE 102 can subsequently receive and/or transmit data while operating in the inactive state. For example, during the time window while the timer is running, and only while the timer is running, the UE 102 monitors a Physical Downlink Control Channel (PDCCH) for a DCI from the base station 104. If the UE 102 is configured with the first RNTI, then the UE 102 can receive the DCI using the first RNTI. The DCI may indicate a configured downlink assignment and/or an uplink grant for the UE 102 to utilize to communicate with the base station 104 when operating in the inactive mode.

At some time after transmitting 312A the message, the UE 102 receives 316A from the base station 104 a C-RNTI. The base station 104 transmits the C-RNTI to the UE 102 in response to receiving the CG from the UE 102. To transmit the C-RNTI, the base station 104 may include the C-RNTI in a MAC PDU or MAC CE.

While the timer is running, the UE 102 detects 318A pending uplink data in a data buffer of the UE 102. Alternatively, in some implementations, the UE 102 may not start 316A the timer. For example, another entity, such as the base station 104, may start 316A a timer, and transmit the UE 102 an indication when the timer expires. In either case, the UE 102 detects 318A the uplink data within a predetermined interval (e.g., the time window of the timer) after transmitting 312A the message. In some implementations, the UE 102 detects a MAC CE instead of or in addition to the uplink data.

In response to detecting 318A the uplink data (and/or a MAC CE), the UE 102 initiates a random access procedure with the base station 104. The UE 102 may initiate the random access procedure in order to transmit a buffer status report (BSR) to the base station 104, or to transmit the uplink data and/or MAC CE. The random access procedure can be a four-step random access procedure (as in the scenario 300A) or a two-step random access procedure (discussed below with reference to FIG. 3B). To initiate the random access procedure, the UE 102 transmits 320A a random access preamble to the base station 104. To transmit the random access preamble, the UE 102 can use either the first type of random access resources or the second type of random access resources. That is, the UE 102 can perform either a non-SDT random access procedure or an SDT procedure.

In response to receiving 320A the random access preamble, the base station 104 transmits 322A a random access response (RAR). Generally speaking, as will be discussed with reference to FIG. 4, a RAR includes a TC-RNTI for the UE 102. However, in the scenario 300A, the base station 104 can omit the TC-RNTI from the RAR because the base station 104 previously transmitted 316A the C-RNTI to the UE 102.

After receiving 322A the RAR, the UE 102 transmits 324A a payload of the random access procedure to the base station 104. The UE 102 can transmit the payload on the Physical Uplink Shared Channel (PUSCH). The payload can include a BSR indicating the uplink data that the UE 102 detected 318A in the data buffer. In other implementations, the payload includes the uplink data and/or MAC CE that the UE 102 detected 318A. To identify the UE 102 to the base station 104, the UE 102 includes the C-RNTI the UE 102 received 316A in the payload. Specifically, the UE 102 may include the C-RNTI in a C-RNTI MAC CE.

In response to receiving 324A the payload, the base station 104 transmits 326A a contention resolution to the UE 102. If the contention resolution includes a C-RNTI MAC CE matching the C-RNTI MAC CE that the UE 102 transmitted 324A, then the UE 102 can determine that the random access procedure is successfully completed. If the random access procedure is an SDT procedure (i.e., based on the type of the random access resources that the UE 102 utilized to initiate the random access procedure), then the UE 102 can remain in the inactive state after the random access procedure. If the random access procedure is a non-SDT procedure, then the UE 102 transitions to the connected state after the random access procedure.

The events 320A, 322A, 324A, and 326A are collectively referred to in this disclosure as a four-step random access procedure 330A, where the events may be, respectively, “Msg1,” “Msg2,” “Msg3,” and “Msg4” of the four-step random access procedure 330A. The Msg3 may be an RRC message, such as an RRCResumeRequest message or an RRCSetupRequest message.

Turning to FIG. 3B, a scenario 300B is generally similar to the scenario 300A, except that the UE 102 initiates a two-step random access procedure instead of a four-step random access procedure. The events 310B, 312B, 314B, 316B, and 318B are similar to the events 310A, 312A, 314A, 316A, and 318A, respectively. The UE 102 initiates a two-step random access procedure by transmitting 320B a random access preamble to the base station 104, similar to the event 320A. The UE 102 also transmits 325B a payload, which includes the same information as the payload that the UE 102 transmits 324A. Thus, the payload includes a C-RNTI MAC CE including the C-RNTI the UE 102 received 316B, and may include a BSR or the uplink data that the UE 102 detected 318B. The events 320B and 325B may collectively be referred to as a “MsgA” of the two-step random access procedure. The random access preamble and the payload are two parts of the MsgA that are sent at different occasions: the UE 102 transmits the random access preamble via a PRACH occasion (e.g., similar to Msg1 of the four-step random access procedure 330), and the UE 102 transmits the payload via a PUSCH occasion (e.g., similar to Msg3 of the four-step random access procedure 330A). In response to the MsgA, the base station 104 transmits 326B a contention resolution and a RAR to the UE 102, where the contention resolution is similar to the contention resolution the base station 104 transmits 326A. The events 320B, 325B, and 326B are collectively referred to in this disclosure as a two-step random access procedure 331B.

Turning to FIG. 4, a scenario 400 is similar to the scenario 300A, except that the UE 102 uses the first RNTI to address the base station 104. Events 410, 412, 414, and 418 are similar to the events 310A, 312A, 314A, and 318A, respectively. In contrast to the scenarios 300A and 300B, the UE 102 does not receive a C-RNTI prior to detecting 418 the uplink data. In response to detecting 418 the uplink data, the UE 102 transmits 420 a random access preamble to the base station 104, similar to the event 320A. In response, the base station 104 transmits 422 a RAR, which may include a TC-RNTI for the UE 102. After receiving 422 the RAR, the UE 102 transmits 424 a payload to the base station 104. Similar to the payload the UE 102 transmits at event 324A, the payload can include a BSR indicating the uplink data, or the uplink data that the UE 102 detected 418. The UE 102 includes in the payload a C-RNTI MAC CE including the first RNTI. In response to the payload, the base station 104 transmits 426 a contention resolution to the UE 102. If the contention resolution includes a C-RNTI MAC CE matching the C-RNTI MAC CE that the UE 102 transmitted 424, then the UE 102 can determine that the random access procedure is successfully completed.

The events 420, 422, 424, and 426 are collectively referred to in this disclosure as a four-step random access procedure 430. While not shown in FIG. 4, the UE 102 can perform a two-step random access procedure rather than the four-step random access procedure, similar to FIG. 3B. If the UE 102 performs a two-step random access procedure, the payload of the MsgA includes the same information as the payload the UE 102 transmits 424. The MsgB includes a contention resolution similar to the contention resolution that the UE 102 transmits 426, and may include a RAR including a TC-RNTI.

Following receiving the TC-RNTI, either in the four-step random access procedure 430 or a corresponding two-step random access procedure, the UE 102 can use 436 the TC-RNTI as a C-RNTI.

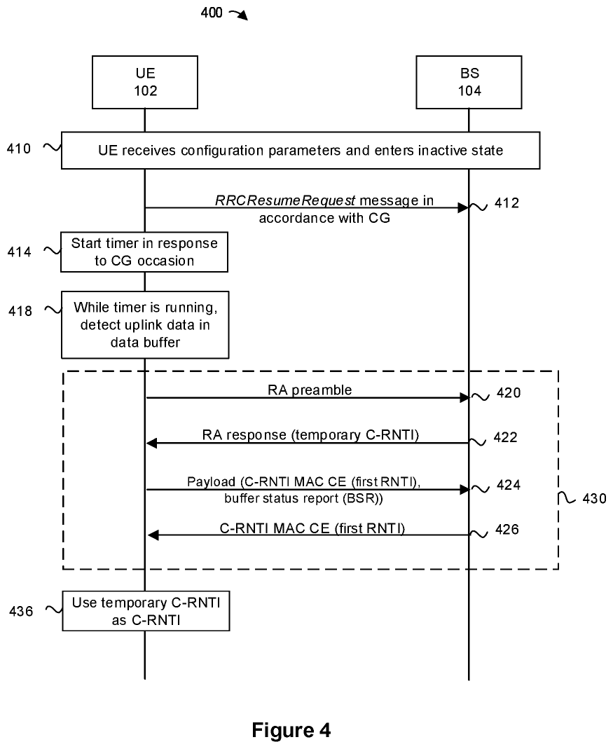

Next, FIG. 5 illustrates a scenario 500 that is similar to the scenario 300A, except that the UE 102 addresses the base station 104 using an indication of the message that the UE 102 previously transmitted to the base station 104 using the configured grant. Events 510, 512, 514, and 518 are similar to the events 310A, 312A, 314A, and 318A, respectively. In contrast to the scenarios 300A and 300B, the UE 102 does not receive a C-RNTI prior to detecting 518 the uplink data. In response to detecting 518 the uplink data, the UE 102 transmits 520 a random access preamble to the base station 104, similar to the event 320A. In response, the base station 104 transmits 522 a RAR, which may include a TC-RNTI for the UE 102. After receiving 522 the RAR, the UE 102 transmits 524 a payload to the base station 104.

The payload includes an indication of the message that the UE 102 previously transmitted 512, which in the scenario 500 is an RRCResumeRequest message. In some implementations, the UE 102 includes the message in the payload. For example, as illustrated in FIG. 5, the UE 102 can include a UE Contention Resolution Identity MAC CE containing the message in the payload. In other implementations, the UE 102 includes a common control channel (CCCH) service data unit (SDU) of the message in a UE Contention Resolution Identity MAC CE in the payload. The payload also includes a BSR and/or the uplink data that the UE 102 detected 518. In response to the payload, the base station 104 transmits 526 a contention resolution to the UE 102. If the contention resolution includes a UE Contention Resolution Identity MAC CE that matches the UE Contention Resolution MAC CE that the UE 102 transmitted 524, then the UE 102 can determine that the random access procedure is successfully completed.

The events 520, 522, 524, and 526 are collectively referred to in this disclosure as a four-step random access procedure 530. While not shown in FIG. 5, the UE 102 can perform a two-step random access procedure rather than the four-step random access procedure, similar to FIG. 3B. If the UE 102 performs a two-step random access procedure, the payload of the MsgA includes the same information as the payload the UE 102 transmits 524. The MsgB includes a contention resolution similar to the contention resolution that the UE 102 transmits 526, and may include a RAR including a TC-RNTI.

Following receiving the TC-RNTI, either in the four-step random access procedure 530 or a corresponding two-step random access procedure, the UE 102 can use 536 the TC-RNTI as a C-RNTI.

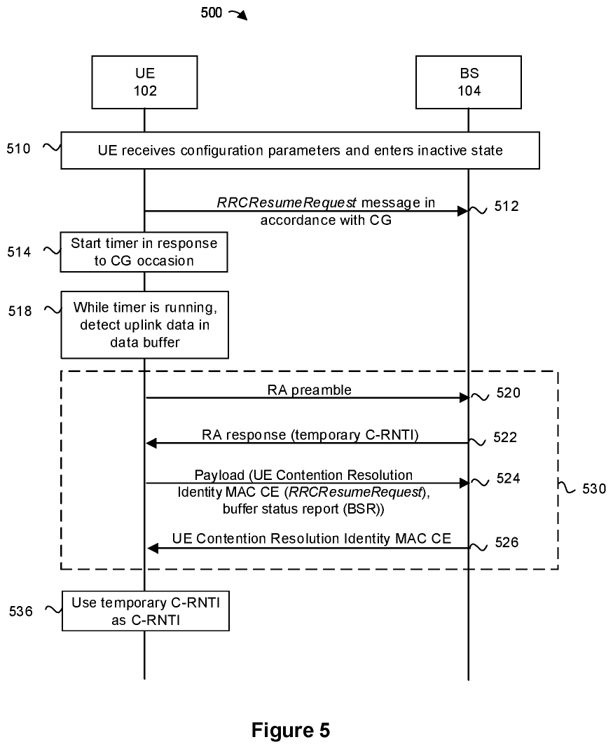

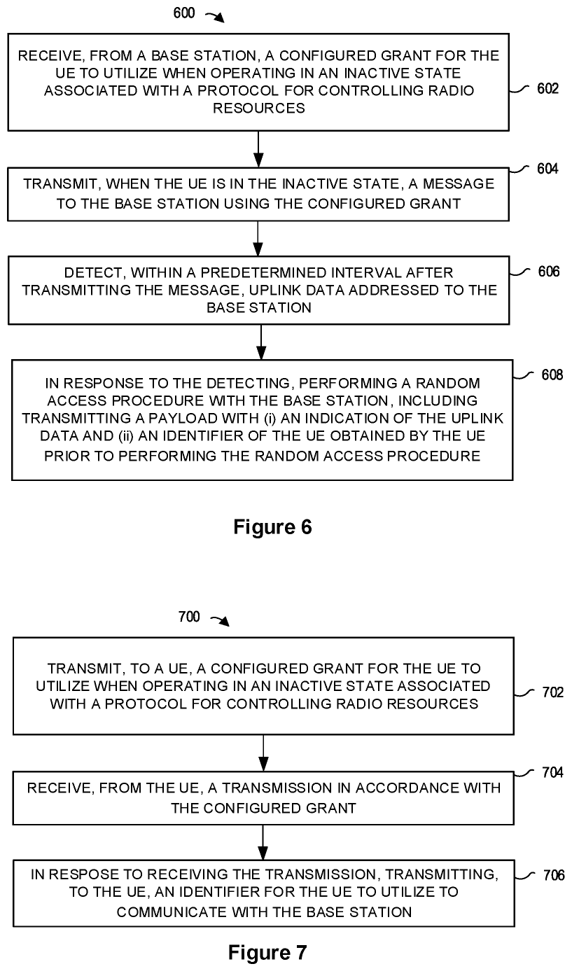

FIGS. 6-7 are flow diagrams of example methods that a base station and/or a UE can implement to perform the techniques of this disclosure.

Referring to FIG. 6, a UE (e.g., the UE 102) can implement an example method 600 to communicate with a base station (e.g., the base station 104). At block 602, the UE receives, from the base station, a configured grant for the UE to utilize when operating in an inactive state associated with a protocol for controlling radio resources (e.g., RRC_INACTIVE) (e.g., event 302A or similar events within procedures 310B, 410, and 510). At block 604, the UE transmits, when the UE is in the inactive state, a message to the base station using the configured grant (e.g., events 312A, 312B, 412, and 512). The message can be, for example, a request to resume or to set up a radio connection with the base station, formatted in accordance with the protocol for controlling radio resources (e.g., an RRCResumeRequest message or an RRCSetupRequest message). At block 606, the UE detects, within a predetermined interval after transmitting the message, uplink data addressed to the base station (e.g., events 318A, 318B, 418, and 518). For example, the UE can start a timer in response to transmitting the message, and detect the uplink data while the timer is running.

At block 608, in response to the detecting, the UE performs a random access procedure with the base station, including transmitting a payload with (i) an indication of the uplink data and (ii) an identifier of the UE obtained by the UE prior to performing the random access procedure (e.g., events 324A, 325B, 424, and 524). The indication of the uplink data may include the uplink data or a status of a data buffer (e.g., a BSR). The payload may include the identifier in a MAC CE. In some implementations, the UE can receive the identifier from the base station after transmitting the message and prior to performing the random access procedure (e.g., the identifier can correspond to the C-RNTI the UE receives at events 324A-B). The UE can receive the identifier in a PDU associated with a MAC layer. In other implementations, the UE can receive the identifier prior to performing the random access procedure, the identifier dedicated for use in the inactive state (e.g., the identifier can correspond to the first RNTI). The UE can receive the identifier in a message that causes the UE to transition to the inactive state (e.g., an RRCRelease message or an RRCReject message). In still other implementations, the identifier corresponds to the message the UE transmitted in accordance with the configured grant. In such implementations, the payload may include a UE Contention Resolution Identity including the message or including a CCCH SDU of the message.

The random access procedure may be a two- or four-step random access procedure. Further, the UE may receive a TC-RNTI in a second message of the random access procedure (e.g., a Msg2 of a four-step random access procedure or a MsgB of a two-step random access procedure). The UE may utilize the TC-RNTI as a C-RNTI after the random access procedure (e.g., events 436, 536). To initiate the random access procedure, the UE can use random access resources (e.g., a random access preamble or a PRACH occasion) dedicated for use in the inactive state (e.g., the second type of random access resources discussed above).

Referring to FIG. 7, a base station (e.g., the base station 104) can implement an example method 700 to communicate with a UE (e.g., the UE 102). At block 702, the base station transmits, to the UE, a configured grant for the UE to utilize when operating in an inactive state associated with a protocol for controlling radio resources (e.g., event 302A or similar events within procedures 310B, 410, and 510). At block 704, the base station receives, from the UE, a transmission in accordance with the configured grant (e.g., events 312A, 312B, 412, and 512). At block 706, in response to receiving the transmission, the base station transmits, to the UE, an identifier for the UE to utilize to communicate with the base station (e.g., events 316A, 316B).

The following list of examples reflects a variety of the embodiments explicitly contemplated by the present disclosure:

Example 1. A method in a user equipment (UE) for communicating with a base station, the method comprising: receiving, by processing hardware of the UE from the base station, a configured grant for the UE to utilize when operating in an inactive state associated with a protocol for controlling radio resources; transmitting, by the processing hardware and when the UE is in the inactive state, a message to the base station using the configured grant; detecting, by the processing hardware and within a predetermined interval after transmitting the message, uplink data addressed to the base station; in response to the detecting, performing, by the processing hardware, a random access procedure with the base station, including transmitting a payload with (i) an indication of the uplink data and (ii) an identifier of the UE obtained by the UE prior to performing the random access procedure.

Example 2. The method of example 1, further comprising: receiving, by the processing hardware after transmitting the message and prior to performing the random access procedure, the identifier from the base station.

Example 3. The method of example 2, wherein the identifier is a cell radio network temporary identifier (C-RNTI).

Example 4. The method of example 2 or 3, wherein receiving the identifier includes receiving the identifier in a protocol data unit (PDU) associated with a medium access control (MAC) layer.

Example 5. The method of example 1, further comprising: receiving, by the processing hardware from the base station prior to performing the random access procedure, the identifier, the identifier dedicated for use in the inactive state.

Example 6. The method of example 5, wherein receiving the identifier includes receiving the identifier in a message that causes the UE to transition to the inactive state.

Example 7. The method of example 1, wherein the identifier corresponds to the message the UE transmitted in accordance with the configured grant.

Example 8. The method of example 7, wherein the payload includes a UE contention resolution identity including the message.

Example 9. The method of example 7, wherein the payload includes a UE contention resolution identity including a common control channel (CCCH) service data unit (SDU) of the message.

Example 10. The method of any one of the preceding examples, wherein the payload includes the identifier in a medium access control (MAC) layer control element.

Example 11. The method of any one of the preceding examples, wherein the message is a request to resume or to set up a radio connection with the base station, formatted in accordance with the protocol for controlling radio resources.

Example 12. The method of any one of the preceding examples, wherein: the message includes first uplink data; and detecting the uplink data includes detecting second uplink data.

Example 13. The method of any one of the preceding examples, wherein detecting the uplink data includes: starting a timer in response to transmitting the message; and detecting the uplink data while the timer is running.

Example 14. The method of any one of the preceding examples, wherein the indication of the uplink data includes a status of a data buffer.

Example 15. The method of any one of the preceding examples, wherein performing the random access procedure includes performing a two-step random access procedure.

Example 16. The method of any one of the preceding examples, wherein performing the random access procedure includes performing a four-step random access procedure.

Example 17. The method of any one of the preceding examples, wherein: performing the random access procedure includes receiving a temporary cell radio network temporary identifier (TC-RNTI) in a second message of the random access procedure, and the method further comprises using the TC-RNTI as a C-RNTI after the random access procedure.

Example 18. The method of any one of the preceding examples, wherein performing the random access procedure further includes transmitting a preamble, the preamble dedicated for use in the inactive state.

Example 19. A user equipment (UE) including processing hardware and configured to implement a method according to any one of the preceding examples.

Example 20. A method in a base station for communicating with a user equipment (UE), the method comprising: transmitting, by processing hardware of the base station to the UE, a configured grant for the UE to utilize when operating in an inactive state associated with a protocol for controlling radio resources; receiving, by the processing hardware from the UE, a transmission in accordance with the configured grant; and in response to receiving the transmission, transmitting, by the processing hardware to the UE, an identifier for the UE to utilize to communicate with the base station.

Example 21. The method of example 20, wherein the transmission includes a request to resume or to set up a radio connection.

Example 22. The method of example 20 or 21, wherein transmitting the identifier includes transmitting the identifier in a protocol data unit (PDU) associated with a medium access control (MAC) layer.

Example 23. The method of any one of examples 20-22, wherein the identifier is a cell radio network temporary identifier (C-RNTI).

Example 24. The method of any one of examples 20-23, further comprising: receiving, by the processing hardware from the UE, a payload during a random access procedure with the UE, the payload including the identifier.

Example 25. The method of example 24, wherein the payload further includes an indication of a status of a data buffer of the UE.

Example 26. A base station including processing hardware and configured to implement a method according to any one of examples 20-25.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for SDT through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a user equipment (UE) for communicating with a base station, the method comprising:
receiving, by the UE from the base station, a configured grant for the UE to utilize when operating in an inactive state associated with a protocol for controlling radio resources;
transmitting, when the UE is in the inactive state, a message to the base station using the configured grant;
detecting, within a predetermined interval after transmitting the message, uplink data addressed to the base station; and
in response to the detecting, performing a random access procedure with the base station, including transmitting a payload with (i) an indication of the uplink data and (ii) an identifier of the UE obtained by the UE prior to performing the random access procedure.

2. The method of claim 1, further comprising:
receiving, after transmitting the message and prior to performing the random access procedure, the identifier from the base station.

3. The method of claim 2, wherein the identifier is a cell radio network temporary identifier (C-RNTI).

4. The method of claim 1, further comprising:
receiving, from the base station prior to performing the random access procedure, the identifier, the identifier dedicated for use in the inactive state.

5. The method of claim 1, wherein the identifier corresponds to the message the UE transmitted in accordance with the configured grant.

6. The method of claim 5, wherein the payload includes a UE contention resolution identity including the message.

7. The method of claim 5, wherein the payload includes a UE contention resolution identity including a common control channel (CCCH) service data unit (SDU) of the message.

8. The method of claim 1, wherein detecting the uplink data includes:
starting a timer in response to transmitting the message; and
detecting the uplink data while the timer is running.

9. The method of claim 1, wherein the indication of the uplink data includes a status of a data buffer.

10. The method of claim 1, wherein:
performing the random access procedure includes receiving a temporary cell radio network temporary identifier (TC-RNTI) in a second message of the random access procedure, and
the method further comprises using the TC-RNTI as a C-RNTI after the random access procedure.

11. A user equipment (UE) including processing hardware and configured to:
receive, by the UE from a base station, a configured grant for the UE to utilize when operating in an inactive state associated with a protocol for controlling radio resources;
transmit, when the UE is in the inactive state, a message to the base station using the configured grant;
detect, within a predetermined interval after transmitting the message, uplink data addressed to the base station; and
in response to the detecting, perform a random access procedure with the base station, including transmit a payload with (i) an indication of the uplink data and (ii) an identifier of the UE obtained by the UE prior to performing the random access procedure.

12. A method in a base station for communicating with a user equipment (UE), the method comprising:
transmitting, by the base station to the UE, a configured grant for the UE to utilize when operating in an inactive state associated with a protocol for controlling radio resources;
receiving, from the UE, a transmission in accordance with the configured grant; and
in response to receiving the transmission, transmitting, to the UE, an identifier for the UE to utilize to communicate with the base station.

13. The method of claim 12, wherein the identifier is a cell radio network temporary identifier (C-RNTI).

14. The method of claim 12, further comprising:
receiving, from the UE, a payload during a random access procedure with the UE, the payload including the identifier.

16. The method of claim 14, wherein the payload includes a UE contention resolution identity including a common control channel (CCCH) service data unit (SDU) of the transmission.

17. The method of claim 14, further comprising:
receiving, during the random access procedure and along with the payload, an indication of uplink data.

18. The method of claim 17, wherein the indication of the uplink data includes a status of a data buffer at the UE.

19. The method of claim 12, wherein the identifier corresponds to the transmission from the UE in accordance with the configured grant.

20. The UE of claim 11, further configured to:
receive, after transmitting the message and prior to performing the random access procedure, the identifier from the base station.

21. The UE of claim 11, further configured to:
receive, from the base station prior to performing the random access procedure, the identifier, the identifier dedicated for use in the inactive state.
